(19) United States
(12) Patent Application Publication
(10) Pub. No.: US 2010/0087115 A1
(43) Pub. Date: Apr. 8, 2010

(54) MICROENCAPSULATION OF A PHASE CHANGE MATERIAL WITH ENHANCED FLAME RESISTANCE

(75) Inventors: Danny Allen Davis, Casstown, OH (US); Dale Ellis Work, London, OH (US); Timothy James Riazzi, Dayton, OH (US)

Correspondence Address: THOMPSON HINE L.L.P.;Intellectual Property Group, P.O. BOX 8801, DAYTON, OH, 45401-8801, US

(73) Assignee: MICROTEK LABORATORIES, INC., Dayton, OH (US)

(21) Appl. No.: 12/575,507

(22) Filed: Oct. 8, 2009

Related U.S. Application Data
(60) Provisional application No. 61/103,592, filed on Oct. 8, 2008.

(51) Int. Cl. C09K 21/00; B01J 13/02; C09K 21/02; D04H 13/00; D03D 25/00; C09K 21/06; C09D 5/18

(52) U.S. Cl. 442/136; 428/402.2; 428/402.21; 428/320.2; 106/15.05

(57) ABSTRACT

A flame-resistant microcapsule that comprises a core comprising a phase change material and a wall material encapsulating the core. The microcapsules includes at least one of: a flame retardant applied to the wall material and a phase change material having a boiling point of about 230° C. to about 420° C. to provided enhanced flame resistance. The phase change material may have a boiling point of about 280° C. to about 400° C. or about 300° C. to about 390° C.

This application claims priority to U.S. Provisional Application Ser. No. 61/103,592 filed Oct. 8, 2008.

### FIELD OF THE INVENTION

The present invention relates generally to microencapsulated phase change materials and more particularly to a microencapsulated phase change material with enhanced flame resistance.

### BACKGROUND OF THE INVENTION

The present invention relates generally to the microencapsulation of phase change materials (“PCM”) that has improved or enhanced flame retardant or fire resistant characteristics. Although the focus of the present application is directed to encapsulation of PCMs, the procedure described herein can also be used to encapsulate a variety of materials, such as fragrances, pharmaceuticals, pesticides, oils, lubricants, and the like.

PCMs may be micro or macro encapsulated and typically the PCM is part of the core and a second material or composition creates the capsule that surrounds the core. See for example U.S. Pat. No. 4,708,812 to Hatfield; U.S. Pat. No. 5,916,478 to Nakahira et al., U.S. Pat. No. 6,619,049 to Wu, and U.S. Pat. No. 6,835,334 to Davis et al.

PCMs have been used in various applications to provide enhanced thermal control by inhibiting flow of thermal energy until a latent heat of the PCM is absorbed or released during a heating or cooling process. In this way thermal energy can be stored or removed from a PCM. The microencapsulated PCM may be incorporated in other products such as building materials, fibers, clothes, and containers for maintaining a set temperature. See U.S. Pat. No. 4,513,053 to Chen et al. and U.S. Pat. No. 6,230,444 to Pause for examples of such building materials, U.S. Pat. No. 4,756,958 to Bryant, U.S. Pat. No. 6,689,466 to Hartmann, U.S. Pat. No. 7,241,497 to Magill et al., and U.S. Pat. No. 7,244,497 to Hartmann et al. for examples of fibers useful in various articles, and U.S. Pat. No. 5,007,478 to Sengupta for an example of a temperature control container.

When PCMs are used in building materials and clothing articles, in particular, the flammability of the PCM may be a concern. Several patents have tried to minimize the flammability of such articles by selecting a PCM that is inherently resistant or by including a flame retardant in the core composition along with the PCM. See U.S. Pat. No. 5,434,376 to Hart et al., U.S. Pat. No. 5,755,216 to Sayler, U.S. Pat. No. 5,770,295 to Alderman, and U.S. Pat. No. 6,230,444 to Pause. Other methods have been attempted for reducing the flammability of an article that incorporates microencapsulated PCMs. The article incorporating the PCM is coated after incorporation of the PCM with a fire-retardant composition or a fire retardant is included as part of the composition of the article that also incorporates the PCM. U.S. Pat. No. 5,788,912 to Saylor teaches treating the surface of a PCM-containing porous product with a urea fire-retarding agent. U.S. Pat. No. 7,241,497 to Magill et al. and U.S. Pat. No. 7,244,497 to Hartmann et al. teach fibers that includes a microencapsulated PCM and other additives, such as a fire retardant in the fiber's composition.

The disclosures of the above-identified patents are incorporated herein by reference.

### SUMMARY OF INVENTION

In one aspect a flame-resistant microcapsule is disclosed that comprises a core comprising a phase change material and a wall material encapsulating the core. The microcapsules includes at least one of: a flame retardant applied to the wall material and a phase change material having a boiling point of about 300° C. or greater to provided improved flame resistance.

In one embodiment the flame resistant microcapsule includes the flame retardant applied to the wall material. The flame retardant may be boric acid, sodium carbonate, sodium silicate, or combinations thereof.

In another embodiment the microcapsule includes the phase change material having a boiling point of about 230° C. to about 420° C. The phase change material may be a synthetic beeswax, a non-halogenated phase change material, or combinations thereof. In another embodiment, the phase change material has a boiling point of about 280° C. to about 400° C. In another embodiment, the phase change material has a boiling point of about 300° C. to about 390° C.

In another embodiment the microcapsules includes the phase change material having a boiling point of about 230° C. to about 420° C. and the flame retardant applied to the wall material. The flame retardant may be boric acid, sodium carbonate, sodium silicate, or combinations thereof and the phase change material may be a synthetic beeswax, a non-halogenated phase change material, or combinations thereof. In another embodiment, the phase change material has a boiling point of about 280° C. to about 400° C. In another embodiment, the phase change material has a boiling point of about 300° C. to about 390° C.

### DETAILED DESCRIPTION OF INVENTION

Microcapsules generally comprise a microencapsulated material contained within a wall and bounded by the wall's material. Phase change materials can be encapsulated in a number of wall materials to contain the PCM and prevent it from leaking out when in a liquid phase.

### PCM Core

In general, a PCM can be any substance (or any mixture of substances) that has the capability of absorbing or releasing thermal energy by means of a phase change within a temperature stabilizing range. The temperature stabilizing range can include a particular transition temperature or a particular range of transition temperatures. A PCM is typically capable of maintaining a temperature condition during a time when the PCM is absorbing or releasing heat, typically as the PCM undergoes a transition between two states (e.g., liquid and solid states, liquid and gaseous states, solid and gaseous states, or two solid states). Thermal energy may be stored or removed from the PCM, and can effectively be recharged by a source of heat or cold.

PCMs that can be used include various organic and inorganic substances. Organic PCMs may be preferred for the embodiments disclosed herein. Examples of phase change materials include hydrocarbons (e.g., straight-chain alkanes or paraffinic hydrocarbons, branched-chain alkanes, unsaturated hydrocarbons, halogenated hydrocarbons, and alicyclic hydrocarbons), hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids, fatty acid esters, dibasic acids, dibasic esters, 1-halides, primary alcohols, secondary alcohols, tertiary alcohols, aromatic compounds, clathrates, semi-clathrates, gas clathrates, anhydrides (e.g., stearic anhydride), ethylene carbonate, methyl esters, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), sugar alcohols (erythritol, D-mannitol, galactitol, xylitol, D-sorbitol), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers including polyethylene, polyethylene glycol, polyethylene oxide, polypropylene, polypropylene glycol, or polytetramethylene glycol), metals, and mixtures thereof.

The selection of a PCM is typically dependent upon the transition temperature that is desired for a particular application that is going to include the PCM. The transition temperature is the temperature or range of temperatures at which the PCM experiences a phase change from solid to liquid or liquid to solid. For example, a PCM having a transition temperature near room temperature or normal body temperature can be desirable for clothing applications. A phase change material according to some embodiments of the invention can have a transition temperature in the range of about −5° C. to about 125° C. In one embodiment, the transition temperature is about 6° C. to about 37° C. In another embodiment, the transition temperature is about 15° C. to about 30° C. In another embodiment, the PCM has a transition temperature of about 30° C. to about 45° C.

Paraffinic PCMs may be a paraffinic hydrocarbons, that is, hydrocarbons represented by the formula CₙHₙ₊₂, where n can range from about 10 to about 44 carbon atoms. PCMs useful in the invention include paraffinic hydrocarbons having 13 to 28 carbon atoms. For example, the melting point of a homologous series of paraffin hydrocarbons is directly related to the number of carbon atoms as shown in the following table:

| Compound Name | # Carbon Atoms | Melting Point (° C.) |
|---|---|---|
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

Methyl ester PCMs may be any methyl ester that has the capability of absorbing or releasing thermal energy to reduce or eliminate heat flow within a temperature stabilizing range. In one embodiment, the methyl ester may be methyl palmitate. Examples of other methyl esters include methyl formate,methyl esters of fatty acids such as methyl caprylate, methyl caprate, methyl laurate, methyl myristate, methyl palmitate, methyl stearate, methyl arachidate, methyl behenate, methyl lignocerate and fatty acids such as caproic acid, caprylic acid, lauric acid, myristic acid, palmitic acid, stearic acid, arachidic acid, behenic acid, lignoceric acid and cerotic acid; and fatty acid alcohols such as capryl alcohol, lauryl alcohol, myristyl alcohol, cetyl alcohol, stearyl alcohol, arachidyl alcohol, behenyl alcohol, lignoceryl alcohol, ceryl alcohol, montanyl alcohol, myricyl alcohol, and geddyl alcohol.

In fact, substantially any PCM (commonly a hydrophobic PCMs) which can be dispersed in water and microencapsulated by the technology referenced herein and may be useful in the present microencapsulated PCM. Alternately, two or more different PCMs can be used to address particular temperature ranges and such materials can be mixed. PCMs are commercially available from PCM Energy P. Ltd, Mumbai, India, Entropy Solutions Inc., Minneapolis, Minn., and Renewable Alternatives, Columbia, Mo.

Applicant has found that encapsulating a PCM that has a boiling point of about 230° C. to about 420° C., preferably about 280° C. to about 400° C., and more preferably about 300° C. to about 390° C. provides enhanced flame resistance. The PCM may be a synthetic beeswax, a non-halogenated PCM, or any currently existing or later developed PCM that has a boiling point within these temperature ranges. In one embodiment, the PCM is a synthetic beeswax (a derivative mixture of fatty acid esters) having a melting point of 28° C. and a boiling point greater than 300° C. In another embodiment, the microcapsule additionally has a flame retardant applied to the microcapsule wall as discussed in more detail below.

### Encapsulation

Any of a variety of processes known in the art may be used to microencapsulate PCMs in accordance with the present invention. Microcapsule production may be achieved by physical methods such as spray drying or by centrifugal and fluidized beds.

The microencapsulated material may be provided using any suitable capsule chemistry. Chemical techniques may be used, such as dispersing droplets of molten PCM in an aqueous solution and to form walls around the droplets using simple or complex coacervation, interfacial polymerization and in situ polymerization all of which are well known in the art. For example, methods are well known in the art to form gelatin capsules by coacervation, polyurethane or polyurea capsules by interfacial polymerization, and urea-formaldehyde, urea-resorcinol-formaldehyde, and melamine formaldehyde capsules by in situ polymerization. U.S. Pat. No. 6,619,049, herein incorporated by reference, discloses a method for microencapsulating a PCM in a melamine formaldehyde resin.

The wall material may comprise a polyacrylate, as described in, for instance, U.S. Pat. No. 4,552,811. Gelatin or gelatin-containing microcapsule wall materials are well known. The teachings of the phase separation processes, or coacervation processes, are described in U.S. Pat. Nos. 2,800,457 and 2,800,458 and gel-coated capsules, as purportedly described in U.S. Pat. No. 6,099,894 further may be employed in connection with the invention.

Interfacial polymerization is a process wherein a microcapsule wall of a polyamide, an epoxy resin, a polyurethane, a polyurea or the like is formed at an interface between two phases. U.S. Pat. No. 4,622,267 discloses an interfacial polymerization technique for preparation of microcapsules. The core material is initially dissolved in a solvent and an aliphatic diisocyanate soluble in the solvent mixture is added. Subsequently, a nonsolvent for the aliphatic diisocyanate is added until the turbidity point is just barely reached. This organic phase is then emulsified in an aqueous solution, and a reactive amine is added to the aqueous phase. The amine diffuses to the interface, where it reacts with the diisocyanate to form polymeric polyurethane shells. A similar technique, used to encapsulate salts which are sparingly soluble in water in polyurethane shells, is disclosed in U.S. Pat. No. 4,547,429.

U.S. Pat. No. 3,516,941 teaches polymerization reactions in which the material to be encapsulated, or core material, is dissolved in an organic, hydrophobic oil phase which is dispersed in an aqueous phase. The aqueous phase has dissolved materials forming aminoplast resin which upon polymerization form the wall of the microcapsule. A dispersion of fine oil droplets is prepared using high shear agitation. Addition of an acid catalyst initiates the polycondensation forming the aminoplast resin within the aqueous phase, resulting in the formation of an aminoplast polymer, which is insoluble in both phases. As the polymerization advances, the aminoplast polymer separates from the aqueous phase and deposits on the surface of the dispersed droplets of the oil phase to form a capsule wall at the interface of the two phases, thus encapsulating the core material. This process produces the microcapsules. Polymerizations that involve amines and aldehydes are known as aminoplast encapsulations.

Urea-formaldehyde (UF), urea-resorcinol-formaldehyde (URF), urea-melamine-formaldehyde (UMF), and melamine-formaldehyde (MF) capsule formations proceed in a like manner. In interfacial polymerization, the materials to form the capsule wall are in separate phases, one in an aqueous phase and the other in a fill phase. Polymerization occurs at the phase boundary. Thus, a polymeric capsule shell wall forms at the interface of the two phases thereby encapsulating the core material. Wall formation of polyester, polyamide, and polyurea capsules proceeds via interfacial polymerization.

Processes of microencapsulation that involve the polymerization of urea and formaldehyde, monomeric or low molecular weight polymers of dimethylol urea or methylated dimethylol urea, melamine and formaldehyde, monomeric or low molecular weight polymers of methylol melamine or methylated methylol melamine are taught in U.S. Pat. No. 4,552,811. These materials are dispersed in an aqueous vehicle and the reaction is conducted in the presence of acrylic acid-alkyl acrylate copolymers. Preferably, the wall forming material is free of carboxylic acid anhydride or limited so as not to exceed 0.5 weight percent of the wall material.

An in situ polymerization based manufacturing technique of microencapsulating phase change materials (PCMs) using polyurea-formaldehydes is taught in an article by N. Sarier and E. Onder, The Manufacture of microencapsulated phase change materials suitable for the design of thermally enhanced fabrics. Thermochimica Acta 452 (2) (2007) 149-160, herein incorporated by reference. A method of encapsulating by in situ polymerization, including a reaction between melamine and formaldehyde or polycondensation of monomeric or low molecular weight polymers of methylol melamine or etherified methylol melamine in an aqueous vehicle conducted in the presence of negatively-charged, carboxyl-substituted linear aliphatic hydrocarbon polyelectrolyte material dissolved in the vehicle is disclosed in U.S. Pat. No. 4,100,103.

A method of encapsulating by polymerizing urea and formaldehyde in the presence of gum arabic is disclosed in U.S. Pat. No. 4,221,710. This patent further discloses that anionic high molecular weight electrolytes can also be employed with gum arabic. Examples of the anionic high molecular weight electrolytes include acrylic acid copolymers. Specific examples of acrylic acid copolymers include copolymers of alky acrylates and acrylic acid including methyl acrylate-acrylic acid, ethyl acrylate-acrylic acid, butyl acrylate-acrylic acid and octyl acrylate-acrylic acid copolymers. A method for preparing microcapsules by polymerizing urea and formaldehyde in the presence of an anionic polyelectrolyte and an ammonium salt of an acid is disclosed in U.S. Pat. Nos. 4,251,386 and 4,356,109. Examples of the anionic polyelectrolytes include copolymers of acrylic acid. Examples include copolymers of alkyl acrylates and acrylic acid including methyl acrylate-acrylic acid, ethyl acrylate-acrylic acid, butyl acrylate-acrylic acid and octyl acrylate-acrylic acid copolymers.

Other microencapsulation methods are known. For instance, a method of encapsulation by a reaction between urea and formaldehyde or polycondensation of monomeric or low molecular weight polymers of dimethylol urea or methylated dimethylol urea in an aqueous vehicle conducted in the presence of negatively-charged, carboxyl-substituted, linear aliphatic hydrocarbon polyelectrolyte material dissolved in the vehicle, is taught in U.S. Pat. Nos. 4,001,140; 4,087,376; and 4,089,802.

In one embodiment, the wall material for encapsulating the PCM contains a melamine-formaldehyde resin. In an alternate embodiment, the microcapsule may be a dual walled capsule. Dual wall capsules, such as first wall-second wall structures of an acrylic polymer and an urea-resorcinal-gluteraldehyde (URG), an acrylic polymer and an urea-resorcinal-formaldehyde (URF), a melamine-formaldehyde and a URF, a melamine-formaldehyde and a URG, or a URF and a melamine-formaldehyde, respectively, as disclosed in U.S. Published Patent Application 2006/0063001, herein incorporated by reference.

The microcapsules will typically have a relatively high payload of PCM of about 60% to 85%. In one embodiment, the phase change material is present at about 70% to 80% by weight. The PCM may be one or a combination of the PCMs described above.

The size of the microcapsules typically range from about 0.01 to 100 microns and more typically from about 2 to 50 microns. The capsule size selected will depend on the application in which the microencapsulated PCM is used. For example, they may be used as the thermal transfer medium in a heat transfer fluid for use in lasers, supercomputers and other applications requiring high thermal transfer efficiencies. They also may be coated on fibers or incorporated into fibers to prepare insulative fabrics. They may be added to plastics or resins such as polypropylene and acrylics and spun into fibers or extruded into filaments, beads or pellets useful in thermal transfer applications such as insulative apparel such as clothes, shoes, boots, etc., building insulation for use in walls, floors, etc. For use in heat transfer fluids, the capsule size may range from about 1 to 100 microns and more typically from about 2 to 40 microns. For use in fibers, yarns, or textile the capsule size may be about 1 to 15 microns or about 2 to 10 microns. For other applications, the capsule size range is about 0.5 microns to about 10 microns.

These microencapsulated PCM may be made of different wall thicknesses. Typically the wall material should be thick enough to contain the PCM while in its liquid phase without allowing the PCM to leak through the wall or to be permeable therethrough. The wall thickness may be about 0.1 to about 0.9 microns. In one embodiment, the wall may be about 0.2 to about 0.6 microns thick with a nominal (mean) thickness of about 0.4 microns. The capsule walls should be sufficiently thick to avoid rupture when processed into other materials or products, such as those discussed above.

Those skilled in the art will appreciate that the capsule size and wall thickness may be varied by many known methods, for instance, adjusting the amount of mixing energy applied to the materials immediately before wall formation commences. Capsule wall thickness is also dependent upon many variables, including the speed of the mixing unit used in the encapsulation process.

Other microencapsulation processes known in the art or otherwise found to be suitable for use with the invention may be employed. In one embodiment, a plurality of microencapsulated PCMs having the same or different encapsulation may be contained in “macrocapsules” as disclosed in U.S. Pat. No. 6,703,127 and No. 5,415,222, herein incorporated by reference in their entirety. Macrocapsules may provide a thermal energy storage composition that more efficiently absorbs or releases thermal energy during a heating or a cooling process than individual microencapsulated PCMs.

### Flame Retardant

Various flame retardants may be used to enhance flame resistance of an encapsulated phase change material. In one embodiment, the flame retardant may contain one or more of boric acid, borates, ammonium polyphosphates, sodium carbonate, sodium silicate, aluminum hydroxide, magnesium hydroxide, antimony trioxide, various hydrates, tetrakis(hydroxymethyl)phosphonium salts, halocarbons, including chlorendic acid derivates, halogenated phosphorus compounds including tri-o-cresyl phosphate, tris(2,3-dibromopropyl)phosphate (TRIS), bis(2,3-dibromopropyl)phosphate, tris(1-aziridinyl)-phosphine oxide (TEPA), and others.

The flame retardant may be applied to the wall material as a solution, dispersion, a suspension, or a colloid that forms a coating on the wall material to provide flame resistant characteristics to the microencapsulated PCM. The flame retardant may be present in an amount to make about a 2% to about a 50% flame retardant solution, dispersion, suspension, or colloid. In another embodiment, the flame retardant may be present in an amount to make about a 5% to about a 30% flame retardant solution, dispersion, suspension, or colloid. Any solvent may be used dissolve, mix, or suspend the flame retardant without decomposing or reacting with the flame retardant, the wall material, or any other solvents present. The solvent may be water, an aliphatic or aromatic solvent, and/or an alcohol. The application of the flame retardant as a solution, dispersion, suspension, or colloid (the flame retardant medium) is advantageous because it provides a relatively simple manufacturing process as seen in the Examples below and described in more detail in the Method section below.

### Method

Disclosed herein is a method for making a microencapsulated phase change material having flame resistance. The method may include providing an encapsulated phase change material and applying a composition containing a flame retardant to the encapsulated phase change material. The flame retardant composition may contain any of the flame retardants described above or a combination thereof and may be present in a solution, dispersion, suspension, or colloid in the concentrations given above.

The flame retardant composition may be applied by spraying, pan coating, or by using a fluidized bed, industrial blender, or other various types of mixers and/or blenders. In another embodiment, the encapsulated PCMs may be suspended in a composition containing the flame retardant to allow a coating to form on the outer surface of the microcapsule wall. The composition may be a solution, dispersion, suspension, or colloid, as described above. The encapsulated PCMs way be added to the composition as a powder, wet cake, or as a slurry. A slurry may be advantageous in mixing more quickly with the composition.

The flame retardant is applied in an amount of about 5% to about 30% flame retardant by weight of the coated microcapsule.

To vary the percent by weight of the flame retardant coating on the microencapsulated PCMS the amount of time the microencapsulated PCMs remains in or is coated with the flame retardant medium may be altered. Theoretically, there is likely an amount of time that even if exceeded will not deposit more flame retardant on the microcapsules as an equilibrium state may be achieved between the flame retardant in the flame retardant medium and the amount of flame retardant deposited on the microcapsules. Alternately, the amount or concentration of flame retardant in the flame retardant medium may also affect the amount of flame retardant deposited as well as the time it takes to deposit the desired amount of flame retardant. One skilled in the art will also recognize that other factors may affect the time and amount of flame retardant deposited such as temperature, pressure, agitation of the medium, etc.

After the flame retardant coating is applied the coated microcapsules are removed from the composition and are dried. The removal of the coated encapsulated PCMs from the solution, dispersion, suspension, or colloid may be by any conventional process, such as filtering or centrifuging. The coated encapsulated PCMs may be dried thereafter using any convention process, such as air drying, oven drying, spray drying, or fluid bed drying. The coated microcapsules may be dried to about a 5% moisture content or less. The microcapsules may have a moisture content of about 1% to about 2%. Alternately, rather than drying the coated encapsulated PCMS, the microcapsules may be contained as a wet cake. The wet cake may have a moisture content of about 30%.

The coated encapsulated PCMs may have a variety of uses because many industries may be able to take advantage of the coated capsules flame resistance. The flame resistant encapsulated PCMs may be incorporated into a number of articles such as textile materials, building materials, packaging materials, and electronic devices. Textile materials may have the coated encapsulated PCMs incorporated into the fiber and/or fabrics they are made of The textile material may be used to make clothing items, window treatments, and medical wraps to provide flame resistance and the thermal characteristics of the PCM. Building materials may include the flame resistant encapsulated PCMs on or in them, such as insulation, lumber, roofing materials, and floor and ceiling tiles. Packaging materials may include food serving trays, bubble wrap, packaging peanuts, labels, cardboard, paper, and insulated containers. Electronic devices may include the coated encapsulated PCMs to remove heat from electrical components that may be damaged by heat, such as computers, televisions, or any other machine with electronic components. The coated encapsulated PCMs may also be incorporated into a binder to provide a coating useful in many applications, such as paints, sprays, etc. that may even be useful in applying the coated encapsulated PCMs to the items described above.

The present invention is further illustrated by the following non-limiting examples.

### Example 1

PCM microcapsules of 22 μm having a melamine formaldehyde based wall and 70% by weight octadecane, available commercially from Microtek, were used to form the flame retardant coated microcapsule described below. A batch of 500 g of the microencapsulated octadecane was suspended in enough water to make a slurry. The slurry was filtered using a Buchner vacuum filter into a wet cake. The wet cake had a solid microcapsule content of about 61%. The wet cake was divided into four 100 g samples to be treated with a flame retardant.

Three solutions containing the flame retardants as listed in Table 2, below, were prepared. Distilled water was used as a control in this experiment.

TABLE 2
Microencapsulated Octadecane Samples

| Microencapsulated | |
|---|---|
| Octadecane Sample | Flame Retardant Solution |
| 1 | distilled water |
| 2 | 5% boric acid solution (aq.) |
| 3 | 28% sodium carbonate solution (aq.) |
| 4 | 28% sodium carbonate and 8% sodium |
| | silicate solution (aq.) |

The 5% boric acid solution was prepared by dissolving 5 g of boric acid in 100 mL of distilled water. The 28% sodium carbonate solution was prepared by dissolving 14 g of sodium carbonate in 50 mL of distilled water. The 28% sodium carbonate and 8% sodium silicate solution was prepared by dissolving 14 g of sodium carbonate and 4 g of sodium silicate in 50 mL of distilled water.

Then each of the four 100 g samples of the PCM microcapsules in their wet cake form were separately suspended in 100 mL of distilled water. Each sample was then filtered. Next, each sample was separately resuspended in the Flame Retardant Solutions shown in Table 2 above. The samples kept in the Flame Retardant Solution for 30 minutes and thereafter were filtered and air-dried to a moisture content of about 1%.

To test the flame resistance of the dried Samples, four insulation test samples were prepared by separately combining 120 g of cellulose insulation with 24 g of each of the dried treated microencapsulated octadecane. Cellulose insulation was placed in a blender to form a fluffy loose mass. The microcapsules were then added to the fluffy mass and gently blended again throughout the insulation. The flame resistance of each insulation test sample was analyzed utilizing the ASTM C1485-00 test procedure for Critical Radiant Flux of Exposed Attic Floor Insulation. For the insulation to be considered flame resistent the distance the flame traveled on the insulation surface from ignition to the point of flame-out should not be more than 44 cm. Samples 2-4, which respectively contained the flame retardant coatings identified in Table 2, did not have a flame that progressed past 44 cm on the insulation's surface, thus the insulation containing the PCM microcapsules pasted the ASTM C1485-00 test. In particular, the flame in these tests, on average, did not progress past 42 cm.

### Example 2

The same procedure as described in Example 1 was repeated for PCM microcapsules of 21 μm having a melamine formaldehyde based wall and 70% by weight methyl palmitate, available commercially from Microtek. The flame resistance of the four samples were likewise tested utilizing the ASTM C 1485-00 test procedure and Samples 2-4, which respectively contained the flame retardant coatings identified in Table 2, did not have a flame that progressed past 44 cm on the insulation's surface.

### Example 3

PCM microcapsules of 22 μm having a melamine formaldehyde based wall and a core that is 70% by weight synthetic beeswax (a derivative mixture of fatty acid esters) with a melting point of 28° C. and a boiling point greater than 300° C. were formed according to the procedure in Example one. The wet cake was divided into three samples, which were each treated with a 5% boric acid solution according to the procedure in Example one.

The resulting PCM microcapsules were dried and three insulation test samples were prepared by separately combining 120 g of cellulose insulation with 24 g of each of the PCM microcapsules, as explained in Example one. Each insulation test sample was analyzed utilizing the ASTM C 1485-00 test procedure and performed remarkably better than the successful samples in Examples one and two. The three insulation test samples containing the synthetic beeswax PCM experienced flame burn-out at 34 cm, 35 cm, and 36 cm.

What is claimed is:

1. A flame-resistant microcapsule comprising:
a core comprising a phase change material; and
a wall material encapsulating the core to form a microcapsule;
wherein the microcapsule includes at least one of: a flame retardant applied to the wall material, and the phase change material having a boiling point of about 230° C. to about 420° C.

2. The microcapsule of claim 1 wherein the wall material is selected from the group consisting of melamine formaldehyde resin, gelatin, polyurea, polyurethane, urea-formaldehyde resin, and combinations thereof.

3. The microcapsule of claim 1 wherein the microcapsule includes the flame retardant and the flame retardant is at least one of boric acid, sodium carbonate, and sodium silicate.

4. The microcapsule of claim 3 wherein the phase change material is a paraffinic or a fatty acid ester phase change material.

5. The microcapsule of claim 3 wherein the flame retardant is applied to the wall material as a solution, a dispersion, a suspension, or a colloid containing about 5% to about 30% of the flame retardant.

6. The microcapsule of claim 1 wherein the core is about 60% to about 85% by weight of microcapsule.

7. The microcapsule of claim 6 wherein the core is about 70% to 80% by weight of the microcapsule.

8. The microcapsule of claim 1 wherein the microcapsule includes the phase change material having a boiling point of about 300° C. or greater and the phase change material is selected from the group consisting of a synthetic beeswax, a non-halogenated phase change material, and combinations thereof.

9. The microcapsule of claim 8 wherein the microcapsule also includes the flame retardant applied to the wall material.

10. The microcapsule of claim 9 wherein the flame retardant is at least one of boric acid, sodium carbonate, and sodium silicate.

11. The microcapsule of claim 1 wherein the phase change material has a boiling point of about 280° C. to about 400° C.

12. The microcapsule of claim 1 wherein the phase change material has a boiling point of about 300° C. to about 390° C.

13. The microcapsule of claim 8 wherein the phase change material is about 60% to about 85% by weight of the microcapsule.

14. A textile material comprising a fabric or fiber containing the microcapsule of claim 1.

15. The textile material of claim 14 wherein the fiber or fabric is included in an item of apparel.

16. A building material including the microcapsule of claim 1.

17. The building material of claim 16 wherein the building material is insulation.

18. A packaging material including the microcapsule of claim 1.

19. An electronic device including the microcapsule of claim 1.

20. A coating composition including the microcapsule of claim 1.
